(19) United States
(12) Patent Application Publication
(10) Pub. No.: US 2026/0129485 A1
(43) Pub. Date: May 7, 2026

(54) METHODS FOR EXPLAINABLE AI BASED PERFORMANCE MONITORING

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Mihaela Beluri, Jericho, NY (US); Akshay Malhotra, San Jose, CA (US)

(73) Assignee: InterDigital Patent Holdings, Inc., Wilmington, DE (US)

(21) Appl. No.: 18/936,532

(22) Filed: Nov. 4, 2024

(51) Int. Cl. H04W 24/08; G06N 5/045; H04B 7/0404

(52) U.S. Cl. CPC H04W 24/08; G06N 5/045; H04B 7/0404

(57) ABSTRACT

A wireless transmit/receive unit (WTRU) may receive configuration information. The configuration information may include criteria for an explainable artificial intelligence (XAI) model to determine a root cause failure (RCF) of a first model. The configuration information may include reporting configuration information and/or a condition associated with at least one XAI metric to determine a RCF type associated with the first model. The WTRU may determine the at least one XAI metric based on an evaluation of the first model. The WTRU may determine the RCF type associated with the first model based on the at least one XAI metric. The WTRU may determine one or more actions based on the determined RCF type. The WTRU may send a report in accordance with the reporting configuration information. The report may indicate the RCF type.

### BACKGROUND

Development of AI/ML framework may include one or more use cases (e.g. channel state information (CSI) feedback enhancements, beam management, positioning). Model life cycle management (LCM) may be a function included in the AI/ML functional framework (e.g., for NR air interface). LCM may include AI/ML model development, deployment, and/or management during the life cycle.

### SUMMARY

A wireless transmit/receive unit (WTRU) may receive configuration information for explainable artificial intelligence (XAI)-based model performance monitoring. A WTRU may activate an XAI model based on one or more satisfied triggers. A WTRU may determine the root-cause failure (RCF) of the inference model. A WTRU may determine a recommended recovery action. The WTRU may transmit a XAI report.

A wireless transmit/receive unit (WTRU) may receive configuration information. The configuration information may include criteria for an explainable artificial intelligence (XAI) model to determine a root cause failure (RCF) of a first model. For example, the XAI-based model may be configured to monitor performance of the first model to determine the RCF of the first model. The configuration information may include reporting configuration information and/or a condition associated with at least one XAI metric to determine a RCF type associated with the first model. The WTRU may determine the at least one XAI metric based on an evaluation of the first model. The WTRU may determine the RCF type associated with the first model based on the at least one XAI metric. The WTRU may determine one or more actions based on the determined RCF type. The WTRU may send a report in accordance with the reporting configuration information. The report may indicate the RCF type.

The condition associated with the at least one XAI metric may include one or more of: a minimum score associated with the at least one XAI metric; a maximum score associated with the at least one XAI metric; a rank associated with an impact of one or more input features of the first model; a count of a number of input features of the first model that have a score greater than or less than a first threshold; a mean score associated with one or more input features of the first model; and/or a variance of the scores associated with one or more input features of the first model.

The determined RCF type may correspond to one of a first RCF type or a second RCF type. The first RCF type may be associated with a failure due to one or more input features of the first model causing performance degradation of the first model. The second RCF type may be associated with a failure due to the first model causing performance degradation of the first model. When the RCF type is the first RCF type, the one or more actions may include masking and/or replacing one or more input features associated with the first model.

The determined XAI metric may correspond to a value determined by the XAI model based on one or more outputs from the first model. The at least one XAI metric may include a respective score determined for each of a plurality of input features for the first model. The evaluation of the first model may include performing one or more XAI measurements associated with the first model, based on the criteria, to determine the one or more XAI outcomes.

The at least one XAI metric may be determined based on the criteria. The criteria may include one or more of: performance conditions, AI/ML inference model conditions, time-based conditions, a confidence level of the first model, and/or an indication from a network.

The configuration information may include an indication of one or more trigger conditions that cause the WTRU to execute the XAI model on the first model. The WTRU may determine the at least one XAI metric based on the one or more trigger conditions being satisfied.

Sending the report may include sending an indication of the one or more actions.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example flow chart diagram.

### DETAILED DESCRIPTION

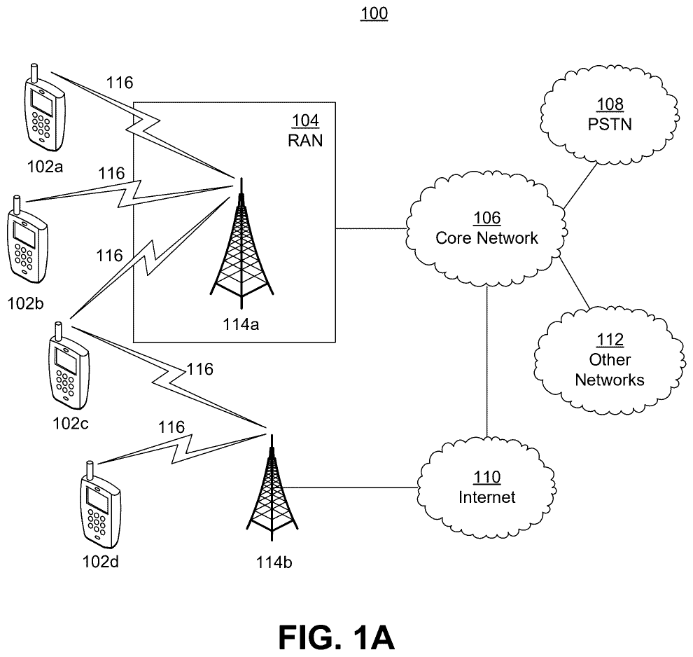

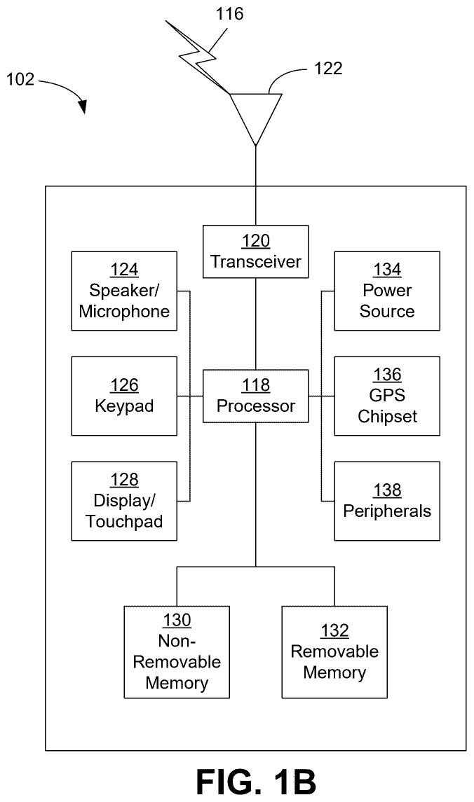

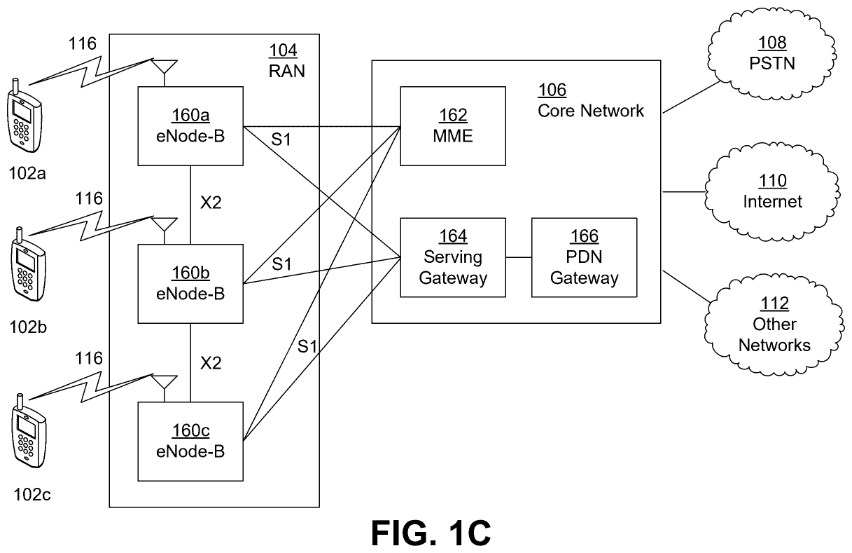

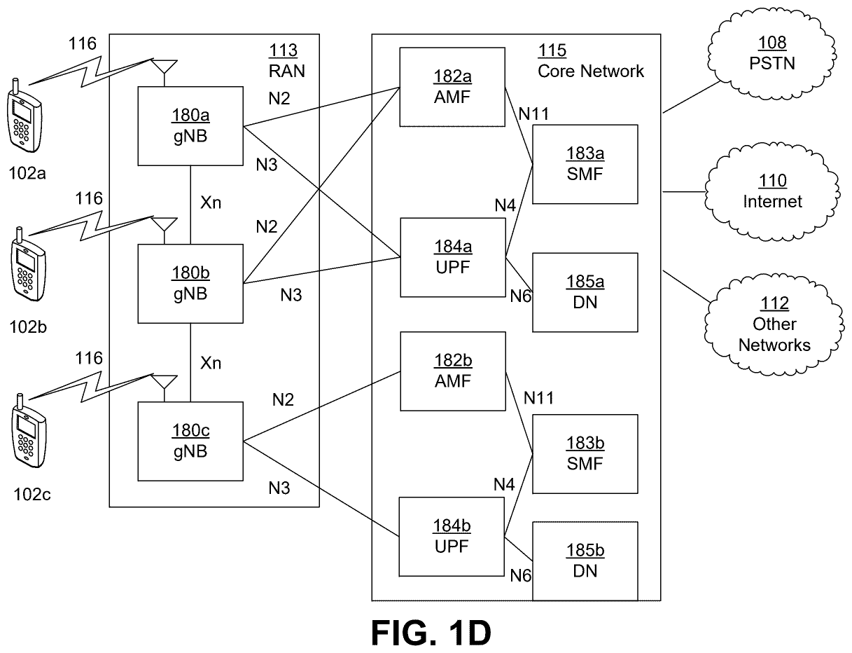

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Life cycle management of artificial intelligence (AI)/machine learning (ML) models (e.g., for NR air interface) may be described herein. Development of AI/ML framework may include one or more use cases (e.g. channel state information (CSI) feedback enhancements, beam management, positioning). Model life cycle management (LCM) may be a function included in the AI/ML functional framework (e.g., for NR air interface). LCM may include AI/ML model development, deployment, and/or management during the life cycle. Performance management and/or monitoring of the AI/ML model(s) may be included to ensure stable performance across different scenarios, channel condition(s), deployments, configurations, etc. Instability of AI/ML performance may occur based on ML models may not generalize well, especially when there is a large inconsistency between training data and inference/testing data. This may make performance monitoring a key LCM component for AI/ML-enabled features, including functions as computing monitored performance metrics, reporting monitoring results, and/or signaling mechanisms to (e.g., smoothly) recover from failure.

As the AI/ML model(s) complexity grow, often involving millions and/or billions of parameters, AI/ML model(s) decision-making processes may become more opaque. This complexity, while resulting in performance improvement of the AI/ML models, may raise (e.g., significant) challenges in understanding and/or interpreting how these models arrive at their conclusions/decisions. With transparency and trustworthiness being two aspects (e.g., key aspects) of the (e.g., 6G) wireless systems, for example, the lack of understanding of how the AI/ML models work may make transparency and/or trustworthiness cumbersome tasks to achieve, especially with high complexity AI/ML models. This is where explainable AI (XAI) may become essential. XAI may refer to methods and/or techniques that produce accurate and/or explainable model of how AI algorithm arrives at a specific decision. By identifying the underlying logic of AI models, XAI may help ensure transparency and/or accountability to enable trustworthy AI-based embodiments in (e.g., future) wireless systems. XAI may help users understand what decision(s) are made and/or why they are made. XAI may help in addressing concerns related to safety and bias/fairness of the AI/ML model(s).

XAI can be developed throughout the entire development of the model. Explainability strategies can be categorized into pre-model explanations, in-model explanations, and/or post-model explanations. The Pre-model explanations may aim to describe the dataset to gain (e.g., meaningful) insights about the dataset used to train the model. In-model explanations may seek to inherently generate explainable models (e.g., other than black-box models). This can be attained by adopting inherently explainable model(s) (e.g., decision trees, linear models). For example, an inherently explainable model may include a hybrid model that can be somehow adjusted, for example, through architectural adjustments (e.g., combining a deeply hidden layer of neural network with k-nearest node (KNN) to enable explanations). The third category of explainability strategy may include post-model explanations, and/or model-agnostic X model that can explain the outcomes of one or more (e.g., any) AI/ML model. Of the existing XAI techniques, local interpretable model-agnostic explanations (LIME) and shapely additive explanations (SHAP) may be model-agnostic explainable AI techniques that can provide post-model explanations. LIME may provide local explanations (e.g., per-feature/sample) by providing scores associated with the impact of each input feature using simple linear approximations of the original AI model. SHAP may provide (e.g., both) local and/or global explanation(s) of a particular AI model at a higher computational cost compared to LIME.

A challenge towards integrating reliable ML embodiments into the (e.g., next generation) wireless systems may include having an efficient model monitoring process. Prior art may include model monitoring through measuring the model performance (e.g., using intermediate key performance indicators (KPIs) and/or end-to-end KPIs) and/or may decides a model failure if the performance drops (e.g., below a configured threshold). This may result in taking an action associated with the model itself (e.g., retraining and/or model switch). Identifying the model as the reason of failure may not necessarily be correct, and the resulting action on the model may be costly and/or infeasible. Explainable AI may be used as means to overcome the aforementioned issues, for example, by providing a detailed explanation of the model failure; using explainable AI may result in a more accurate monitoring framework and/or more efficient model life cycle management. By offering insights into how models generate predictions, XAI may help identify potential issues, improve model accuracy, and/or ensure robust testing, making it easier to diagnose and/or resolve problems throughout the model life cycle.

A challenge may include how to translate and/or map the XAI model explanation to the root-cause failure (RCF) of the AI model under monitoring, and/or how to determine the (e.g., appropriate) action(s) based on the identified RCF to keep the model alive and/or working (e.g., properly). One or more of the following may be addressed. How to determine the XAI model explanations and/or how to translate the XAI model outcome(s) to the RCF of the model under monitoring may be addressed. How to determine the improvement action(s) to resolve the identified (RCF) may be addressed. What are the triggers for performing XAI-based monitoring may be addressed. How to report the XAI model outcome, and/or the identified RCF along with the improvement action to the network (NW) may be addressed.

Embodiments described herein may include WTRU procedures for XAI-based performance monitoring and/or RCF determination. WTRU procedures for determining the RCF of the inference model and/or recommended action(s) as a function of one or more measurements and/or output of the XAI model satisfying configured criteria for performance requirements.

A WTRU may receive configuration information for XAI-based model performance monitoring. The configuration information may include one or more of the following.

The configuration information may include criteria and/or one or more rules, one or more conditions, and/or one or more triggers (e.g., trigger conditions). The configuration information may include an indication of the one or more trigger conditions that cause the WTRU to execute the XAI model on the first model. The criteria may be associated with one or more of a AI/ML use-case specific performance threshold, NW-based indication(s) of model failure (e.g., a failure flag), time-based criteria, model-switch criteria, confidence level of inference model criteria, and/or one or more measurements. The criteria associated with a AI/ML use-case specific performance threshold may include a channel state information (CSI) prediction (e.g., average squared generalized cosine similarity (SGCS)/normalized mean square error (NMSE) over a configured period of time falls below a threshold), a beam prediction (e.g., difference between prediction (previous beam index) and current prediction (current beam index) is greater than a threshold), and/or a precoding matrix indicator (PMI)/channel quality indicator (CQI) selection (e.g., difference between previously selected beam/CQI index and current selected beam/CQI index is greater than a threshold, especially for low/moderate speed scenarios). Time-based criteria may include reporting explanations every N inference rounds/cycles and/or every NCSI reports in case of CSI use-cases (e.g., CSI compression), and/or every few seconds and/or minutes, timer for the last time the first model was validated. Model-switch criteria may include activating a model for the first time and/or activating a model after a certain time period. Confidence level of inference model criteria may include confidence level associated with the inference model output is below a threshold. Criteria associated with one or more measurements (e.g., performed by the WTRU) may include beam failure measurements (e.g., radio link failure (RLF) measurement(s), reference signal received power (RSRP) is less than a threshold, reference signal received quality (RSRQ) is less than a threshold, signal to interference plus noise ratio (SINR) is less than a threshold) and/or (e.g., consecutive) number of negative acknowledgements (NACKs) is greater than a configured threshold. For example, the WTRU may receive configuration information that includes criteria for an explainable artificial intelligence (XAI) model to determine a root cause failure (RCF) of a first model. The configuration information may include reporting configuration and/or a condition associated with at least one XAI metric to determine a RCF type associated with the first model. The condition associated with the at least one metric may include one or more: a minimum score associated with the at least one XAI metric; a maximum score associated with the at least one XAI metric; a rank associated with an impact of one or more input features of the first model; a count of a number of input features of the first model that have a score greater than or less than a first threshold; a mean score associated with one or more input features of the first model; and/or a variance of the scores associated with one or more input features of the first model.

The configuration information may include reporting configuration for the XAI-based model performance monitoring. For example, reporting configuration may include resources for reporting, periodicity, and/or a XAI metric (e.g., function of the XAI model outcome(s)). The XAI metric may be use-case specific. The XAI metric may be associated with a XAI model. For example, for CSI prediction, the XAI metric may be the order of the input features (historical CSI) from importance perspective and/or may be evaluated against one or more ordered sets (e.g. may be configured and/or determined by the WTRU); the XAI metric may be the number of K-most impactful features compared against the threshold. For example, for temporal spatial frequency (TSF), the XAI metric may be the minimum allowed score associated with each sample in the observed window compared against a threshold. The XAI metric may be used to determine the RCF type, and/or it may be use-case specific. For example, the XAI metric may be the order/rank of the features compared against a configured ordered sets. If there is a difference between the XAI metric and the configured set, for example, the WTRU may determine the RCF type 1. If the XAI metric is the number of K most impactful features, for example, the WTRU may compare the number against a threshold and/or may determine RCF type 1 if the measured number is less than the configured threshold.

A WTRU may run an XAI model. For example, the WTRU may run the XAI model when one or more triggers are satisfied. The WTRU may determine the XAI outcome(s) (e.g., individual score associated with each input feature and/or inference associated with the XAI model and/or may determine the XAI metric associated with the XAI outcome(s) based on, for example, use case specific condition(s). For example, the WTRU may determine the at least one XAI metric based on an evaluation of the first model. The evaluation of the first model may include the WTRU being configured to perform one or more XAI measurements associated with the first model, based on the criteria, to determine the one or more XAI outcomes. The at least one XAI metric may be determined based on the criteria. The criteria may include one or more of performance condition(s), AI/ML inference model condition(s), time-based condition(s), a confidence level of the first model, and/or an indication from a network of the one or more triggers that cause the WTRU to execute the XAI model on the first model. The WTRU may determine the at least one XAI metric based on the one or more trigger conditions being satisfied.

A WTRU may determine the RCF type of the inference model, for example, based on comparing the measured (e.g., determined) XAI metric with the configured XAI metric. The WTRU may determine the RCF type associated with the first model based on the at least one XAI metric. The determined RCF type may correspond to one of a first RCF type or a second RCF type. For example, the RCF type may be RCF type 1 or RCF type 2. The first RCF type may be associated with a failure due to one or more input features of the first model causing performance degradation of the first model. RCF type 1 may include input features and/or a subset thereof. RCF type 1 may be detected based on comparing the measured XAI metric against the configured XAI metric. For example, for the CSI prediction use-case, a WTRU may measure the sorted outcome (e.g., high to low importance) of the historical CSI value resulting from the XAI model and/or may compare it against one or more configured ordered sets—may result in updating the observation window to resolve the failure. For example, for TSF, RCF type 1 may include the minimum score associated with an input temporal sample is below a configured threshold. For the channel estimation (CHEST) use-case, RCF type 1 may include a number of irrelevant subcarriers (e.g., with scores less than a threshold) from XAI model exceeds a configured threshold. For CSI compression, RCF type 1 may include a number and/or indices of irrelevant sub-bands/resource blocks (RBs) obtained from XAI model exceeds a configured threshold; the irrelevant sub-bands may be breaking the correlation behavior in the frequency domain resulting in inefficient compression (e.g., may incur higher reconstruction error). Irrelevant subbands may be removed and/or replaced to improve performance. RCF type 2 may include an inference model (e.g., if none of the criteria for RCF type 1 is met). For example, the second RCF type may be associated with a failure due to the inference model (e.g., first model) causing performance degradation of the first model (e.g., inference model).

A WTRU may determine one or more recommended actions to resolve the determined RCF, for example, based on the determined RCF type and/or the configured condition(s). The WTRU may determine one or more actions based on the determined RCF type. For RCF type 1, a WTRU may perform and/or report one or more of the following. A WTRU may mask a subset of the input features (e.g., select a subset of the input features to use as the model input and/or may disregard others (replace with zeros)). When the RCF type is the first RCF type, the one or more actions may include masking and/or replacing one or more input features associated with the first (e.g., inference) model. For example, the WTRU may choose and/or report a number and/or indices of input CSI samples to a CSI prediction and/or TSF model for the NW to reconfigure (e.g., drop one or more of the subcarriers for CSI compression). For RCF type 1, a WTRU may replace a subset of the input features. For example, for multi-step CSI predictions, the WTRU may use the predicted output as t+1 s an input for predicting t+2, where one or more (e.g., all) predictions may be reported in the same report. Using the predicted output as an input may (e.g., further) improve the prediction performance (e.g., as opposed to using one or more old input samples). For RCF 2, the WTRU may recommend and/or report one or more of the following. If the model works (e.g., in a subset of scenarios), the WTRU may recommend and/or report deactivating and/or switching the model. If the model is not available (e.g., for some time), the WTRU may fine-tune and/or update the model. The WTRU may recommend and/or report disregarding a model, for example, if another (e.g., new) model is expected (e.g., retraining, model download).

A WTRU may send a report. The report may include the determined RCF type, recommended action, and/or the determined XAI metric, for example, based on one or more of the following: periodically (e.g., XAI report may be indicated every n configured period); when condition(s) are satisfied (e.g., when RCF is detected and/or measured performance is greater than a threshold); and/or actual signaling may be based on layer 1 (L1) and/or radio resource control (RRC) and/or medium access control (MAC) control element (CE). For example, the WTRU may send a report in accordance with the reporting configuration information. The report may indicate the RCF type. The report may include an indication of the one or more actions. The report may include one or more (e.g., determined) XAI metrics.

Embodiments described herein may include an efficient model monitoring framework through using XAI, which may explain how the model prediction(s) and/or decision(s) are made. Using XAI may result in accurately identifying the RCF of the AI/ML model under monitoring. This may be beneficial when there are one or more (e.g., multiple) causes that can impact the model performance (e.g., model itself and/or something about the input features); knowing the correct cause of model failure can result in a more efficient model life cycle management process.

Embodiments described herein may include a WTRU procedure for XAI based performance monitoring and/or RCF detection.

A first AI/ML model may refer to the AI/ML model that is to be explained. The terms first AI/ML model, inference model, and/or AI/ML model may be used interchangeably to indicate the model is to be explained.

A second AI/ML model may refer to the model used to explain and/or characterize the first AI/ML model. For example, the second model may be explainable AI (XAI) model (e.g., LIME) that is used to provide explanation(s) for the AI/ML inference model. The explanation(s) may be associated with the inference model input and/or output.

A XAI outcome may refer to one or more outputs of the XAI model. A first output may represent score and/or weights representing the importance of the input features with respect to the input of the AI/ML inference model. A second output may represent the inference decision associated with the XAI model.

A XAI metric may refer to a function and/or post-processing of the XAI outcome (e.g., the K feature indices with the highest scores and/or weights). For example, a binary vector with 1 may indicate that an input feature score exceeds a certain threshold and 0 otherwise.

A RCF may refer to the root-cause failure type associated with the AI/ML inference model. The RCF may represent the fundamental reason why the inference model did not perform as expected and/or fails to produce desired results.

A WTRU may be configured with XAI-based monitoring. A WTRU supporting XAI model(s) may be configured to perform one or more XAI measurements for one or more of its AI/ML inference models, for example, for model performance monitoring for LCM. The configuration may include criteria to perform XAI measurements and/or XAI reporting configuration. The configuration may include one or more of: performance condition(s), AI/ML inference model condition(s), indication from the NW, and/or time-based conditions. XAI reporting configuration may include XAI measurements, determined RCF, ad/or the recommended actions to resolve the RCF.

The criteria to perform XAI measurements and/or XAI reporting configuration may be configured using radio resource control (RRC) configuration, for example, during initial configuration, upon handover to another (e.g., new) cell, and/or upon activation of other (e.g., new) AI/ML models and/or functionality.

The criteria to perform XAI measurements may include performance conditions. The performance conditions may be use-case specific. The performance conditions may include one or more of the following.

The performance conditions may include a specified metric associated with the AI/ML inference model meeting a configured threshold. The specified metric may be an intermediate KPI measured at the output of the AI/ML inference model. For example, for the CSI prediction use case, the metric may be the SGCS of the predicted CSI, averaged over a configured window, and/r the condition may be the average SGCS being lower than a configured SGCS threshold. In examples, for the CSI prediction use case, the metric may be the NMSE of the predicted CSI, averaged over a configured window, and/or the condition may be the average NMSE exceeding a configured NMSE threshold. In examples, for the beam management use case, the metric may be the predicted beam index, and/or the condition may be the difference between the current beam prediction (beam index) and a previous beam prediction (beam index) exceeding a configured threshold. In examples, the metric may be the PMI/CQI selection, for example for AI/ML based CSI feedback, and/or the condition may be the difference between the current selected PMI/CQI index and a previous PMI/CQI index exceeding a configured threshold. The threshold may be predefined, for example as a fixed value, and/or as a function of the WTRU speed; the WTRU may determine that the condition(s) to perform XAI measurements are met if the difference between the current selected PMI/CQI index and a previous PMI/CQI index exceeds the threshold corresponding to the current WTRU speed.

The performance conditions may include a WTRU measured system and/or end-to-end metrics. In examples, the WTRU may be configured to perform XAI measurements when it determines that WTRU measured system and/or end-to-end metrics meet configured criteria. For example, the metric may be the RSRP, RSRQ, and/or SINR (e.g., averaged over a configured window), and/or the condition may be the average RSRP, RSRQ and/or SINR being lower than a configured threshold. In examples, the metric may be the WTRU determination of a beam failure and/or a radio link failure (RLF). In examples, the metric may be indicative of the performance of the data channel (e.g., the ACK/NACK indicator) and/or the condition may be that the number of consecutive NACKs is greater than a configured threshold.

The criteria to perform XAI measurements may include AI/ML inference model conditions (e.g., model-switch and/or model activation, confidence level of AI/ML inference model). In examples, a WTRU may be configured to perform XAI measurements after switching to and/or activating an AI/ML model, for example, to determine a first set (e.g., a reference set) of XAI measurements for the activated AI/ML inference model. In examples, a WTRU may perform XAI measurements at the end of a configured window (e.g., time window) after the AI/ML inference model was activated. In examples, a WTRU may be configured to measure the confidence level associated with the AI/ML inference model output(s), and/or the condition may be that the measured confidence level is below a configured threshold.

The criteria to perform XAI measurements may include time-based conditions (e.g., periodicity type of XAI measurements, number of consecutive inference cycles, period for performing XAI measurements). For example, a WTRU may be configured to perform periodic, semi-persistent, and/or aperiodic XAI measurements. A WTRU may be configured to provide explanations (e.g., XAI outcomes, XAI metrics) every N inference occasions (e.g., when configured for periodic XAI measurements). For example, in case of CSI feedback, a WTRU may be configured to provide XAI measurements every N CSI reporting occasions, where the number N of CSI reporting occasions may be configured via RRC. When a WTRU is configured for periodic XAI measurements, for example, the WTRU may be configured with a timer value (e.g., in units of seconds, minutes) and/or counter values (e.g., in units of slots, TTIs and/or frames) between consecutive XAI measurements.

The criteria to perform XAI measurements may include indication from the NW (e.g., for aperiodic XAI measurements). A WTRU may receive a NW-based indication of AI/ML inference model failure (e.g., a failure flag) and/or an indication of the model (e.g., model ID) and/or functionality to be explained, for example, when the WTRU supports one or more (e.g., multiple) AI/ML inference models. A WTRU may receive a request from the NW to report one or more XAI measurements. The request may include an indication of the XAI outcome(s) and/or the XAI metric(s) to be reported, an indication of the AI/ML inference model, and/or functionality to be explained. The XAI measurement indication from the NW may be signaled to the WTRU via RRC, MAC CE, and/or downlink control information (DCI).

The XAI reporting configuration may include which XAI measurement(s) to be reported, the reporting type (e.g., periodic, semi-persistent, and/or aperiodic), and/or one or more resources for reporting. The XAI measurements to be reported may include one or more of the following: XAI metric(s) and/or XAI outcome(s). A WTRU may be configured to report use-case specific XAI metrics, for example, when the WTRU supports AI/ML inference models for one or more (e.g., multiple) use cases. For example, for AI/ML based CSI prediction, the WTRU may be configured to report the order of the input features (e.g., historical CSI), which may be evaluated against one or mode ordered sets. In examples, for AI/ML based CSI prediction, the WTRU may be configured to report the number of most impactful features compared against a configured threshold. In examples, for CSI compression using temporal-spatial-frequency domain information, the reported XAI may be the minimum allowed score associated with each sample in the observed window.

The XAI reporting configuration may include one or more resources for reporting the WTRU-determined root-cause failure (RCF) type of the AI/ML inference model, and/or an identifier (e.g., model ID or functionality ID) of the AI/ML inference model being explained. The XAI reporting configuration may include the one or more recommended actions to resolve the RCF, including one or more resources for the recommended RCF resolution action. When one or more configured XAI conditions are met, for example, the WTRU may be triggered to run the XAI model and/or determine the XAI outcome(s) and XAI metric(s).

In examples, a WTRU may be configured with a first AI model and/or an associated second AI model. The first AI model may be used for a specific use case (e.g., beam management, positioning, CSI feedback enhancement). The second AI model may be used to characterize/explain/comprehend the operation/output/performance of the first AI model. In examples, the second AI model may take as input one or more of the following: the first AI model; one or more inputs to the first AI model; and/or one or more outputs from the first AI model. In examples, the second AI model may include an XAI model. The frequency of running the XAI model may be smaller than the frequency of running the inference model, where running the XAI model may be based on the performance (e.g., performance degradation) of the inference model.

Triggers to activate/run the XAI model may include one or more of the following of the following. Triggers to activate/run the XAI model may include time. For example, the WTRU may be configured with time instances, and/or slots, and/or periodicity type when the WTRU may activate the XAI model. In examples, the time may be a function of the inference model runs (inferences) (e.g., run the XAI model every N inference occasions). Triggers to activate/run the XAI model may include performance of inference model (e.g., when the performance of the inference model falls below a configured threshold). Triggers to activate/run the XAI model may include a change in scenario and/or configuration associated with the inference model. For example, a WTRU may be indicated a change in scenario and/or configuration associated with the inference model. Scenarios may include one or more of: WTRU mobility (e.g., speed); channel/environment type (e.g., indoor/outdoor); link type (e.g., line of sight (LOS), non-LOS (NLOS)); and/or the like. The configuration may include one or more of a carrier frequency, a band-width part, and/or an antenna layout. Triggers to activate/run the XAI model may include the occurrence of an inference model event. For example, events may include one or more of: model retraining, finetuning, switching, and/or deactivation of the model. Triggers to activate/run the XAI model may include a change to one or more inference model performance monitoring parameters (e.g., one or more parameters falling below a threshold). For example, the monitoring parameters may include one or more of: confidence level of the inference model output/decision/prediction, convergence parameter(s) of the inference model. Triggers to activate/run the XAI model may include a system performance associated function (e.g., rate of HARQ-NACK when the number of NACKs exceeds a configured threshold). For example, the XAI model may run when one or more parameters are above a threshold (e.g., the XAI model may be activated if the number of NACKs exceeds a threshold). Triggers to activate/run the XAI model may include a failure and/or change in one or more link conditions (e.g., upon beam failure, upon radio link failure, upon handover failure, etc.). Triggers to activate/run the XAI model may include a status of a previous feedback. For example, the WTRU may activate the XAI model if previous feedback associated with the inference model is dropped and/or received at the NW with error (e.g., based on cyclic redundancy check (CRC)).

A WTRU may determine a RCF type. In examples, the WTRU may be configured to generate the XAI outcome when one or more of the trigger conditions (e.g., as described herein) is satisfied. The AI/ML model that is to be explained may be referred to as the inference model (e.g., first model) and the associated output may be referred to as the inference model output/prediction/decision. The XAI outcome may represent one or more outputs of the XAI model. A first output may represent a score and/or weightage value associated with each input feature indicating the importance/contribution/impact of that specific feature on the inference model output. The higher the score and/or weightage of an input feature, the higher the contribution of that specific feature to the inference model decision. A second output may represent the inference result associated with the XAI model. In examples, the inference model itself may be self-explainable (e.g., decision trees and/or linear models). In examples, one or more of the XAI outcomes may be obtained and/or derived from the inference model itself.

In examples, the WTRU may be configured to determine an XAI metric. The determined XAI metric may correspond to a value determined by the XAI model based on one or more outputs from the first (e.g., inference) model. The XAI metric may be a function of one or more of the XAI outcomes. The WTRU and/or a network may evaluate one or more determined XAI metrics. The WTRU may send (e.g., report) one or more (e.g., determined) XAI metrics to the network. The at least one XAI metric may include a respective score determined for each of a plurality of input features for the first (e.g., inference) model. For example, XAI metric associated with the first output, denoted as Sₓ and may represent the scores associated with an N-dimensional input feature vector x, may be one of the following. XAI metric 1 may refer to the metric f_{X}, which may be a binary vector output with value 1 if the score associated with the corresponding feature is greater than a threshold α and 0. Otherwise, for example,

$${f}_{x} ( n ) = \{ \begin{matrix}1 , & S ( n ) > α \\ 0 , & otherwise\end{matrix} , \\ n = 1 , … , N$$

XAI metric 2 may refer to the metric f_{X}, which may be a rank of features (e.g., a K-dimensional vector representing the indices of the K most impactful/contributor input features, where 1≤K≤N, where the K most impactful feature(s) may include the ones with the highest scores. The value of K may be configured by the NW and/or determined by the WTRU. XAI metric 3 may refer to the metric f_{X}, which may be the number of features with scores greater/less than a configured threshold. XAI metric 4 may refer to the metric f_{X}, which may be the maximum and/or minimum score along with the corresponding feature index. XAI metric 5 may refer to the metric f_{X}, which may be the statistic(s) associated with the score(s) vector Sₓ, (e.g., mean and/or variance of the feature score(s)).

In examples, the WTRU may be configured to determine and/or report the root-cause failure of a target inference model (e.g., first model). The root-cause failure may refer to the underlying reason why the inference model outputs an undesired result and/or why the performance of the inference model (e.g., first model) degrades. The root-cause failure may include one or more RCF types. A first type of RCF (e.g., RCF 1, RCF Type 1) may be associated with the input features and/or a subset thereof. A second type of RCF (e.g., RCF 2 and/or RCF type 2) may be associated with a failure of the inference model itself. The WTRU may be configured to compute one or more XAI metrics and/or may compare it with a configured metric to identify the RCF type of the inference model. In examples, the configured metric may be use-case specific (e.g., beam management, CSI, positioning, link adaptation, etc.).

In examples, the WTRU may determine/select RCF1 (e.g., identifying a subset of input features that are causing the performance degradation), based on one or more measurements. For example, the WTRU may run the XAI model to identify a set of features with lower scores, (e.g., relative to a threshold and/or relative to the other features scores). This may imply that such features may be negatively impacting the inference model performance. In examples, the WTRU may identify a specific subset of features that may be of high impact in driving the output, for example, based on WTRU side-information, measurements, and/or explicit indication from NW, but XAI outputs low scores for those features. For example, the WTRU may identify one or more outcomes that are inconsistent with one or more expected outcome(s). This may indicate that the input feature(s) may be the driving reason behind the model performance degradation. Described herein are some use-case specific examples for RCF type 1 determination based on the evaluation of the measured XAI metric against a configured metric threshold.

CSI prediction use-case for RCF type 1 is described herein. For the CSI prediction use-case, the WTRU may compute the XAI metric 2, f_{X}, which may be an N-dimensional vector corresponding to the order of input features (e.g., high to low importance) associated with the N-dimensional observation window. The WTRU may compare the computed XAI metric with one or more configured ordered sets/patterns, where the configured patterns may be determined by the NW (e.g., based on feedback collected from one or more WTRUs). In examples, the WTRU may compare the computed XAI metric with a metric determined by the WTRU corresponding to an expected feature pattern (e.g., ordering of the features based on the correlation between predicted sample and the samples in the observation window over a period). The WTRU may determine/select RCF 1, for example, if there is a discrepancy between the measured XAI metric and the WTRU determined metric. In examples, the WTRU may determine/select RCF 1 if there is a discrepancy between the measured XAI metric and the corresponding configured metric (e.g., configured pattern). For example, the discrepancy between the measured XAI metric and the configured metric may be evaluated by counting the number of mismatched indices in the two sorted vectors and compare the number of mismatched indices against a configured threshold.

TSF compression use-case for RCF type 1 is described herein. For the temporal-spatial-frequency (TSF) compression use-case, the WTRU may compute the XAI metric 4, f_{X}, which may be the minimum score associated with the past CSI in the observation window. If one or more (e.g., any) of the past samples in the observation has a score less than a threshold, for example, this sample may be deteriorating the compression performance. The WTRU may compare the measured XAI metric and/or may compare it with the configured metric (e.g., minimum score threshold). The WTRU may determine/select RCF 1 if there is one or more samples with score less than the configured threshold.

Channel estimation use case for RCF type 1 is described herein. In examples, for the channel estimation use-case, the WTRU may compute the XAI metric 3, f_{X}, which may refer to the number of subcarriers with scores less than a configured threshold, denoted as irrelevant subcarriers. If the number of irrelevant subcarriers exceeds a threshold, for example, those set of subcarriers may be impacting the channel estimation accuracy. The WTRU may compare the measured XAI metric and/or may compare it against a configured threshold (e.g., number of irrelevant subcarriers). The WTRU may determine/select RCF 1 if the measured metric is greater than the configured threshold.

CSI compression use case for RCF type 1 is described herein. For the CSI compression use-case, the WTRU may compute the XAI metric 3, f_{X}, which may refer to the number of subbands/RBs/subcarriers with scores less than a configured threshold. If the number of subbands exceeds a threshold, for example, those set(s) of subbands may be impacting the channel compression performance. The WTRU may compare the measured XAI metric and/or compare it against a configured threshold (e.g., number of subbands potentially impacting the reconstruction of other subbands). The WTRU may determine/select RCF 1 if the measured metric is greater than the configured threshold.

If none of the criterions discussed herein are satisfied, for example, the WTRU may determine/select RCF 2, which may indicate that the root-cause failure is the model itself and/or one or more corresponding actions may be applied (e.g., as described herein).

In examples, a WTRU may determine/differentiate different RCF types to determine and/or recommend one or more actions for each RCF type. In examples, the WTRU may use the XAI outcome(s) and/or XAI metric to determine the Root Cause Failure (RCF) of the first model (e.g., inference model). For example, the RCF may be related to a fundamental reason why the first model did not perform as expected and/or fails to produce desired results. In examples, the WTRU may indicate that the root cause failure of inference model is due to the model itself. For example, a first type of RCF (e.g., RCF1) may indicate the failure was due to the input of the inference model. For example, a second type of RCF (e.g., RCF2) may indicate the failure due to the inference model itself. In examples, the WTRU may report and/or recommend one or more mitigation actions to handle (and/or possibly recover from) the failure. The one or more mitigation actions may be a function of type of RCF. In one or more embodiments herein, the terms XAI metric and XAI parameters may be used interchangeably.

A WTRU may determine and/or perform one or more actions with respect to RCF type 1. In examples, the WTRU may be configured to determine one or more mitigation actions to resolve and/or recover from the root-cause failure associated with the input features (RCF1) of the inference model (e.g., a first model). The mitigation action(s) may correspond to one or more of the following. A first mitigation action (e.g., Action 1) may be masking a subset of the input features. For example, a WTRU may select a subset of the of input features to use as the model inputs and may disregard others (e.g., replace with zeros and/or drop them). For example, for the CSI prediction use-case, upon an RCF 1 detection, the WTRU may recommend dropping one or more input historical samples from the observation window. The WTRU may indicate the indices of the samples to be dropped for (e.g., potential) reconfiguration by the NW. For example, for the CSI compression with temporal-spatial-frequency domain use-case, upon an RCF 1 detection, the WTRU may recommend dropping one or more specific samples from the buffers. The WTRU may indicate the number and/or indices of the samples to be dropped to maintain synchronization with the NW-side historical samples. For example, for the CSI compression use-case, upon an RCF 1 detection, the WTRU may recommend to mask one or more of the sub-bands CSI. The WTRU may indicate the indices of the masked subbands for (e.g., proper) reconstruction at the NW side. A second mitigation action (e.g., Action 2), may be replacing a subset of the input features. For example, for the multi-step CSI prediction use-case where the WTRU predicts two or more CSI samples (e.g., in the future), the WTRU may recommend using one or more of the predicted samples (e.g., at time t+1) as an input to predict the sample at time t+2. For example, for a multistep CSI prediction model with observation window length of 5 (the last 5 historical samples) and/or prediction window length of 2 (two samples in the future), the WTRU may recommend replacing one of the past samples (e.g., oldest sample) with the first predicted sample to predict the second sample. This may happen if the accuracy of the first predicted sample is high, so it can positively impact prediction of the second sample.

A WTRU may determine and/or perform one or more actions with respect to RCF type 2. In examples, the WTRU may be configured with a first AI model (e.g., inference AI/ML model) and an associated second AI model (e.g., XAI model)—where the first AI model may be used for a specific use case (e.g., beam management, positioning, CSI feedback enhancement) and the second AI model may be used to characterize/explain/comprehend the operation/output/performance of the first AI model. In examples, the second AI model may take as input one or more of the following: the first AI model, input(s) to the first AI model and/or output(s) from the first AI model. In examples, the second AI model may be an XAI model. In examples, the WTRU may be configured to report the one or more aspects associated with the outcome(s) of the XAI model. For example, the WTRU may be configured to report (e.g., XAI report) the one or more metrics derived based on the outcome(s) of the XAI model. In examples, the WTRU may indicate a first mitigation action (e.g., Action:1)—which may indicate that the inference model works in a subset of scenarios. The WTRU may indicate that the inference model may be deactivated and/or be switched to a different model as the current scenario doesn't belong to one of those subset(s) of scenarios. Mitigation Action:1 may be based on performance monitoring. Mitigation Action:1 may be based on an applicability check at the WTRU—wherein the WTRU side conditions may lead to the inference model being not applicable. Mitigation Action:1 may be based on network side conditions (e.g., associated ID) not compatible with inference model at the WTRU. In examples, the WTRU may indicate a second mitigation action (e.g., Action:2)—which may indicate the inference model at the WTRU is not available for X ms and/or slots. For example, the WTRU may determine that the inference model is to be fine-tuned and/or updated. Time X may be a function of whether the fine tuning happens on-device and/or on the over the top (OTT) server. Time X may be a function of availability of dataset for finetuning. Time X may be a function of WTRU processing capability. Mitigation Action:2 from the WTRU may indicate that the WTRU may require one or more additional measurements/RS transmissions for finetuning. In examples, the WTRU may indicate a third mitigation action (e.g., Action:3)—which may indicate that the current inference model may be retired and/or may not be expected to be available for inference (e.g., in the future). The WTRU may (e.g., further) indicate that another (e.g., new) inference model at the WTRU is expected to be available in X time units. Time units may be expressed in seconds, slots, hours, days, weeks, etc. Such indication may mean that a model transfer and/or download procedure(s) may be initiated.

In examples, the WTRU may be configured with a first AI model and an associated second AI model—where the first AI model may be used for a specific use case (e.g., beam management, positioning, CSI feedback enhancement) and/or second AI model may be used to characterize/explain/comprehend the operation/output/performance of the first AI model. In examples, the second AI model may take as input one or more of the following: the first AI model, input(s) to the first AI model and/or output(s) from the first AI model. In examples, the second AI model may include an XAI model. In examples, the WTRU may be configured to report the one or more aspects associated with the outcome of the XAI model. For example, the WTRU may be configured to report (e.g., XAI report) the one or more metrics derived based on the outcome of the XAI model. In one or more embodiments herein, the terms XAI metric and XAI parameters may be used interchangeably.

In examples, the WTRU may transmit the XAI report in L1 Uplink Control Information. In examples, the WTRU may transmit the XAI report as a part of CSI feedback. Such reporting may be periodic, semi-persistent, and/or event triggered. For example, the WTRU may be configured with a XAI reporting type that indicates one or more of XAI outcome, XAI metric, RCF type, recommended recovery action, etc. For example, the WTRU may be configured with a CSI report quantity that indicates the XAI reporting type. In examples, the WTRU may be configured to transmit XAI report based on expiry of a preconfigured timer. In examples, the WTRU may be configured to transmit XAI report periodically, where the periodicity may be (e.g., implicitly) configured based on the periodicity of a preconfigured reporting resource. In examples, the WTRU may be configured to transmit XAI report periodically, where the periodicity may be (e.g., implicitly) configured based on the periodicity of a RS (e.g., CSI-RS) configured for XAI operation. In examples, the WTRU may be configured to transmit XAI report for every N inferences of the first AI model (e.g., inference model). In examples, the WTRU may be configured to transmit XAI report for every N ms/slots as long as the associated first AI model (e.g., inference model) is active. In examples, the WTRU may be configured to report one or more (e.g., all) of the XAI parameters with same periodicity. In examples, the WTRU may be configured to report different XAI parameters at different periodicity(ies).

In examples, the WTRU may transmit the XAI report in a MAC CE. For example, the WTRU may receive XAI report activation/deactivation command in a MAC CE. When activated, for example, the WTRU may transmit the XAI report in the MAC CE. The XAI activation/deactivation command may include one or more of: a XAI reporting type, an associated inference model ID/functionality ID, a periodicity, a UL resource configuration for reporting, etc. In examples, the WTRU may transmit the XAI report parameter(s) in a RRC message. For example, the WTRU may receive configuration for XAI report in a RRC reconfiguration message. In examples, the WTRU may transmit the XAI report in a RRC reconfiguration complete message. In examples, the WTRU may transmit the XAI report in a WTRU Assistance Information message. In examples, the WTRU may receive XAI report configuration in a WTRU information request message. In examples, the WTRU may transmit the XAI report in a WTRU information response message.

A WTRU may send a report. In examples, the WTRU may be configured to transmit XAI report when one or more preconfigured trigger conditions are satisfied. In examples, the WTRU may be configured with different trigger conditions to report different XAI metrics/outcome/parameters. These conditions may be in part based on the number, value range, and/or status of XAI metric. In examples, the WTRU may be configured to report XAI parameters upon a change in one or more of WTRU-side additional conditions. Such additional conditions may be associated with AI model operation. For example, the WTRU may trigger XAI reporting upon change in one or more measurements (e.g., RSRP, reference signal strength indicator (RSSI), RSRQ, rank indicator (RI), PMI, CQI, SINR, Doppler spread, Doppler shift, delay spread, average delay, position coordinates, WTRU speed). Such change may be relative to one or more previous measurements and/or relative to a preconfigured threshold. For example, the WTRU may trigger XAI report upon detecting a change from NLOS to LOS and/or vice versa. For example, the WTRU may trigger XAI report upon a change in antenna port configuration, band-width part (BWP) configuration, secondary cell (Scell) addition/removal, BWP switch, beam failure, beam recovery, etc. In examples, the WTRU may report XAI metric when fallback/model failure is triggered. In examples, the WTRU may report XAI metric when the WTRU determines the Root Cause Failure (RCF) of the inference model. In examples, the WTRU may report XAI metric based on the performance of the inference model. For example, the WTRU may report XAI metric when the performance of the inference model is above a threshold. For example, the WTRU may report XAI metric when the performance of the inference model is below a threshold. In one or more embodiments herein, the WTRU may transmit XAI report in a configured reporting resource wherein the reporting resource may be PUCCH and/or a PUSCH. In examples, the resource(s) configured for XAI reporting may be a function of content/type of XAI parameters.

Embodiments described herein may include WTRU procedures for XAI-based performance monitoring and/or RCF determination. WTRU procedures for determining the RCF of the inference model and/or recommended action(s) as a function of one or more measurements and/or output of the XAI model satisfying configured criteria for performance requirements.

A WTRU may receive configuration information for XAI-based model performance monitoring. The configuration information may include one or more of the following.

The configuration information may include criteria and/or one or more rules, one or more conditions, and/or one or more triggers. The configuration information may include an indication of the one or more trigger conditions that cause the WTRU to execute the XAI model on the first model. The criteria may be associated with one or more of a AI/ML use-case specific performance threshold, NW-based indication(s) of model failure (e.g., a failure flag), time-based criteria, model-switch criteria, confidence level of inference model criteria, and/or one or more measurements. The criteria associated with a AI/ML use-case specific performance threshold may include a channel state information (CSI) prediction (e.g., average squared generalized cosine similarity (SGCS)/normalized mean square error (NMSE) over a configured period of time falls below a threshold), a beam prediction (e.g., difference between prediction (previous beam index) and current prediction (current beam index) is greater than a threshold), and/or a precoding matrix indicator (PMI)/channel quality indicator (CQI) selection (e.g., difference between previously selected beam/CQI index and current selected beam/CQI index is greater than a threshold, especially for low/moderate speed scenarios).). Time-based criteria may include reporting explanations every N inference rounds/cycles and/or every NCSI reports in case of CSI use-cases (e.g., CSI compression), and/or every few seconds and/or minutes, timer for the last time the first model was validated. Model-switch criteria may include activating a model for the first time and/or activating a model after a certain time period. Confidence level of inference model criteria may include confidence level associated with the inference model output is below a threshold. Criteria associated with one or more measurements (e.g., performed by the WTRU) may include beam failure measurements (e.g., radio link failure (RLF) measurement(s), reference signal received power (RSRP) is less than a threshold, reference signal received quality (RSRQ) is less than a threshold, signal to interference plus noise ratio (SINR) is less than a threshold) and/or (e.g., consecutive) number of negative acknowledgements (NACKs) is greater than a configured threshold. For example, the WTRU may receive configuration information that includes criteria for an explainable artificial intelligence (XAI) model to determine a root cause failure (RCF) of a first model. The configuration information may include reporting configuration and/or a condition associated with at least one XAI metric to determine a RCF type associated with the first model. The condition associated with the at least one metric may include one or more: a minimum score associated with the at least one XAI metric; a maximum score associated with the at least one XAI metric; a rank associated with an impact of one or more input features of the first model; a count of a number of input features of the first model that have a score greater than or less than a first threshold; a mean score associated with one or more input features of the first model; and/or a variance of the scores associated with one or more input features of the first model.

The configuration information may include reporting configuration for the XAI-based model performance monitoring. For example, reporting configuration may include resources for reporting, periodicity, and/or a XAI metric (e.g., function of the XAI model outcome(s)). The XAI metric may be associated with a XAI model. The XAI metric may be use-case specific. For example, for CSI prediction, the XAI metric may be the order of the input features (historical CSI) from importance perspective and/or may be evaluated against one or more ordered sets (e.g. may be configured and/or determined by the WTRU); the XAI metric may be the number of K-most impactful features compared against the threshold. For example, for temporal spatial frequency (TSF), the XAI metric may be the minimum allowed score associated with each sample in the observed window compared against a threshold. The XAI metric may be used to determine the RCF type, and/or it may be use-case specific. For example, the XAI metric may be the order/rank of the features compared against a configured ordered sets. If there is a difference between the XAI metric and the configured set, for example, the WTRU may determine the RCF type 1. If the XAI metric is the number of K most impactful features, for example, the WTRU may compare the number against a threshold and/or may determine RCF type 1 if the measured number is less than the configured threshold.

A WTRU may run an XAI model. For example, the WTRU may run the XAI model when one or more triggers are satisfied. The WTRU may determine the XAI outcome(s) (e.g., individual score associated with each input feature and/or inference associated with the XAI model and/or may determine the XAI metric associated with the XAI outcome(s) based on, for example, use case specific condition(s). For example, the WTRU may determine the at least one XAI metric based on an evaluation of the first model. The evaluation of the first model may include the WTRU being configured to perform one or more XAI measurements associated with the first model, based on the criteria, to determine the one or more XAI outcomes. The at least one XAI metric may be determined based on the criteria. The criteria may include one or more of performance condition(s), AI/ML inference model condition(s), time-based condition(s), a confidence level of the first model, and/or an indication from a network. of the one or more triggers that cause the WTRU to execute the XAI model on the first model. The WTRU may determine the at least one XAI metric based on the one or more trigger conditions being satisfied.

A WTRU may determine the RCF type of the inference model, for example, based on comparing the measured (e.g., determined) XAI metric with the configured XAI metric. The WTRU may determine the RCF type associated with the first model based on the at least one XAI metric. The determined RCF type may correspond to one of a first RCF type or a second RCF type. For example, the RCF may be RCF type 1 or RCF type 2. The first RCF type may be associated with a failure due to one or more input features of the first model causing performance degradation of the first model. RCF type 1 may include input features and/or a subset thereof. RCF type 1 may be detected based on comparing the measured XAI metric against the configured XAI metric. For example, for CSI prediction, a WTRU may measure the sorted outcome (e.g., high to low importance) of the historical CSI value resulting from the XAI model and/or may compare it against one or more configured ordered sets—may result in updating the observation window to resolve the failure. For example, for TSF, RCF type 1 may include the minimum score associated with an input temporal sample is below a configured threshold. For CHEST, RCF type 1 may include a number of irrelevant subcarriers (e.g., with scores less than a threshold) from XAI model exceeds a configured threshold. For CSI compression, RCF type 1 may include a number and/or indices of irrelevant sub-bands/resource blocks (RBs) obtained from XAI model exceeds a configured threshold; may be breaking the correlation behavior in the frequency domain resulting in inefficient compression (e.g., may incur higher reconstruction error). Irrelevant subbands may be removed and/or replaced to improve performance. RCF type 2 may include an inference model (e.g., if non of the criteria for RCF type 1 is met). For example, the second RCF type may be associated with a failure due to the inference model (e.g., first model) causing performance degradation of the first model (e.g., inference model).

A WTRU may determine one or more recommended actions to resolve the determined RCF, for example, based on the determined RCF type and/or the configured condition(s). The WTRU may determine one or more actions based on the determined RCF type. For RCF type 1, a WTRU may perform and/or report one or more of the following. A WTRU may mask a subset of the input features (e.g., select a subset of the input features to use as the model input and/or may disregard others (replace with zeros)). When the RCF type is the first RCF type, the one or more actions may include masking and/or replacing one or more input features associated with the first (e.g., inference) model. For example, the WTRU may choose and/or report a number and/or indices of input CSI samples to a CSI prediction and/or TSF model for the NW to reconfigure (e.g., drop one or more of the subcarriers for CSI compression). For RCF type 1, a WTRU may replace a subset of the input features. For example, for multi-step CSI predictions, the WTRU may use the predicted output as t+1 s an input for predicting t+2, where one or more (e.g., all) predictions may be reported in the same report. Using the predicted output as an input may (e.g., further) improve the prediction performance (e.g., as opposed to using one or more old input samples). For RCF 2, the WTRU may recommend and/or report one or more of the following. If the model works (e.g., in a subset of scenarios), the WTRU may recommend and/or report deactivating and/or switching the model. If the model is not available (e.g., for some time), the WTRU may fine-tune and/or update the model. The WTRU may recommend and/or report disregarding a model, for example, if another (e.g., new) model is expected (e.g., retraining, model download).

A WTRU may send a report. The WTRU may send the report to a network. The report may include the determined RCF type, recommended action, and/or the determined XAI metric, for example, based on one or more of the following: periodically (e.g., XAI report may be indicated every n configured period); when condition(s) are satisfied (e.g., when RCF is detected and/or measured performance is greater than a threshold); and/or actual signaling may be based on layer 1 (L1) and/or radio resource control (RRC) and/or medium access control (MAC) control entity (CE). For example, the WTRU may send a report in accordance with the reporting configuration information. The report may indicate the RCF type. The report may include an indication of the one or more actions. The report may include one or more (e.g., determined) XAI metrics.

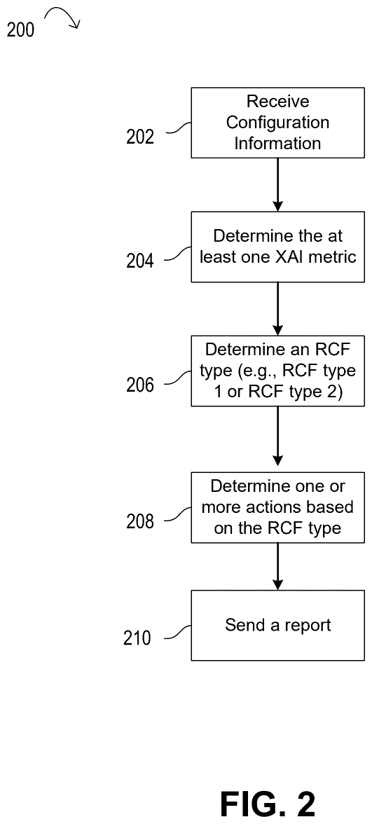

FIG. 2 depicts an example flow chart diagram.

At 202, the WTRU may receive configuration information (e.g., as described herein). The configuration information may include criteria for an explainable artificial intelligence (XAI) model to determine a root cause failure (RCF) of a first model. For example, the XAI-based model may be configured to monitor performance of the first model to determine the RCF of the first model. The configuration information may include an indication of one or more trigger conditions that cause the WTRU to execute the XAI model on the first model. The configuration information may include reporting configuration information and/or a condition associated with at least one XAI metric to determine a RCF type associated with the first model. The condition associated with the at least one XAI metric may include one or more of: a minimum score associated with the at least one XAI metric; a maximum score associated with the at least one XAI metric; a rank associated with an impact of one or more input features of the first model; a count of a number of input features of the first model that have a score greater than or less than a first threshold; a mean score associated with one or more input features of the first model; and/or a variance of the scores associated with one or more input features of the first model.

At 204, the WTRU may determine the at least one XAI metric (e.g., as described herein). For example, the WTRU may determine the at least one XAI metric based on an evaluation of the first model (e.g., as described herein). The WTRU may determine the at least one XAI metric based on the one or more trigger conditions being satisfied. The determined XAI metric may correspond to a value determined by the XAI model based on one or more outputs from the first model. The at least one XAI metric may include a respective score determined for each of a plurality of input features for the first model. The evaluation of the first model may include performing one or more XAI measurements associated with the first model, based on the criteria, to determine the one or more XAI outcomes. The at least one XAI metric may be determined based on the criteria. The criteria may include one or more of: performance conditions, AI/ML inference model conditions, time-based conditions, a confidence level of the first model, and/or an indication from a network.

At 206, the WTRU may determine (e.g., as described herein) the RCF type associated with the first model, for example, based on the at least one XAI metric. The determined RCF type may correspond to one of a first RCF type or a second RCF type. The first RCF type may be associated with a failure due to one or more input features of the first model causing performance degradation of the first model. The second RCF type may be associated with a failure due to the first model causing performance degradation of the first model.

At 208, the WTRU may determine (e.g., as described herein) one or more actions, for example, based on the determined RCF type. For example, when the RCF type is the first RCF type, the one or more actions may include masking and/or replacing one or more input features associated with the first model. For example, when the RCF type is the second RCF type, the one or more actions may include deactivating the first model and/or switching from the first model to another (e.g., new) model.

At 210, the WTRU may send a report. The WTRU may send the report in accordance with the reporting configuration information. The report may indicate the RCF type (e.g., RCF type 1, RCF type 2). The report may include sending an indication of the one or more actions.

1. A wireless transmit/receive unit (WTRU) comprising:
a processor configured to:
receive configuration information, the configuration information comprising criteria for an explainable artificial intelligence (XAI) model to determine a root cause failure (RCF) of a first model, wherein the configuration information comprises reporting configuration information and a condition associated with at least one XAI metric to determine a RCF type associated with the first model;
determine the at least one XAI metric based on an evaluation of the first model;
determine the RCF type associated with the first model based on the at least one XAI metric; and
and
send a report in accordance with the reporting configuration information, wherein the report indicates the RCF type.

2. The WTRU of claim 1, wherein the condition associated with the at least one XAI metric comprises one or more of:
a minimum score associated with the at least one XAI metric;
a maximum score associated with the at least one XAI metric;
a rank associated with an impact of one or more input features of the first model;
a count of a number of input features of the first model that have a score greater than or less than a first threshold;
a mean score associated with one or more input features of the first model; or
a variance of the scores associated with one or more input features of the first model.

3. The WTRU of claim 1, wherein the processor is configured to determine one or more actions based on the determined RCF type, and wherein the determined RCF type corresponds to one of a first RCF type or a second RCF type, wherein the first RCF type is associated with a failure due to one or more input features of the first model causing performance degradation of the first model, and wherein the second RCF type is associated with a failure due to the first model causing performance degradation of the first model.

4. The WTRU of claim 3, when the RCF type is the first RCF type, wherein the one or more actions comprises masking or replacing one or more input features associated with the first model.

5. The WTRU of claim 1, wherein the XAI determined XAI metric corresponds to a value determined by the XAI model based on one or more outputs from the first model.

6. The WTRU of claim 5, wherein the at least one XAI metric comprises a respective score determined for each of a plurality of input features for the first model.

7. The WTRU of claim 1, wherein the evaluation of the first model comprises the processor being configured to perform one or more XAI measurements associated with the first model, based on the criteria, to determine the one or more XAI outcomes.

8. The WTRU of claim 1, wherein the at least one XAI metric is determined based on the criteria, wherein the criteria comprises one or more of: performance conditions, AI/ML inference model conditions, time-based conditions, a confidence level of the first model, or an indication from a network.

9. The WTRU of claim 1, wherein the configuration information comprises an indication of one or more trigger conditions that cause the WTRU to execute the XAI model on the first model, and the processor is configured to determine the at least one XAI metric based on the one or more trigger conditions being satisfied.

10. The WTRU of claim 1, wherein the processor being configured to send the report comprises the processor being configured to send an indication of the one or more actions.

11. A method performed by a wireless transmit/receive unit (WTRU), the method comprising:
receiving configuration information, the configuration information comprising criteria for an explainable artificial intelligence (XAI) model to determine a root cause failure (RCF) of a first model, wherein the configuration information comprises reporting configuration information and a condition associated with at least one XAI metric to determine a RCF type associated with the first model;
determining the at least one XAI metric based on an evaluation of the first model;
determining the RCF type associated with the first model based on the at least one XAI metric; and
sending a report in accordance with the reporting configuration information, wherein the report indicates the RCF type.

12. The method of claim 11, wherein the condition associated with the at least one XAI metric comprises one or more of:
a minimum score associated with the at least one XAI metric;
a maximum score associated with the at least one XAI metric;
a rank associated with an impact of one or more input features of the first model;
a count of a number of input features of the first model that have a score greater than or less than a first threshold;
a mean score associated with one or more input features of the first model; or
a variance of the scores associated with one or more input features of the first model.

13. The method of claim 1, further comprising determining one or more actions based on the determined RCF type, wherein the determined RCF type corresponds to one of a first RCF type or a second RCF type, wherein the first RCF type is associated with a failure due to one or more input features of the first model causing performance degradation of the first model, and wherein the second RCF type is associated with a failure due to the first model causing performance degradation of the first model.

14. The method of claim 13, when the RCF type is the first RCF type, wherein the one or more actions comprises masking or replacing one or more input features associated with the first model.

15. The method of claim 11, wherein the determined XAI metric corresponds to a value determined by the XAI model based on one or more outputs from the first model.

16. The method of claim 15, wherein the at least one XAI metric comprises a respective score determined for each of a plurality of input features for the first model.

17. The method of claim 11, wherein the evaluation of the first model comprises performing one or more XAI measurements associated with the first model, based on the criteria, to determine the one or more XAI outcomes.

18. The method of claim 11, wherein the at least one XAI metric is determined based on the criteria, wherein the criteria comprises one or more of: performance conditions, AI/ML inference model conditions, time-based conditions, a confidence level of the first model, or an indication from a network.

19. The method of claim 11, wherein the configuration information comprises an indication of one or more trigger conditions that cause the WTRU to execute the XAI model on the first model, the at least one XAI metric is determined based on the one or more trigger conditions being satisfied.

20. The method of claim 11, wherein sending the report comprises sending an indication of the one or more actions.
